(19) United States
(12) Patent Application Publication
(10) Pub. No.: US 2024/0169241 A1
(43) Pub. Date: May 23, 2024

(54) Addition of Qubit States Using Entangled Quaternionic Roots of Single-Qubit Gates

(71) Applicant: IonQ, Inc., College Park, MD (US)

(72) Inventors: Dominic WIDDOWS, Bellevue, WA (US); Andrii MAKSYMOV, Hyattsville, MD (US)

(21) Appl. No.: 18/175,946

(22) Filed: Feb. 28, 2023

Related U.S. Application Data
(60) Provisional application No. 63/314,845, filed on Feb. 28, 2022.

(51) Int. Cl. G06N 10/40; G06F 7/552; G06N 10/20

(52) U.S. Cl. CPC G06N 10/40; G06F 7/5525; G06N 10/20

(57) ABSTRACT

Systems and methods are provided for performing addition of qubit states using entangled quaternionic roots of single qubit gates. A method includes identifying a single qubit gate in a quantum circuit of a quantum computer, wherein the quantum circuit includes two summand qubits entangled with a third qubit that stores a measurable non-linear sum of the two summand qubits. The method includes mapping the single qubit gate to a representative gate that is phase-equivalent to the single qubit gate, mapping the representative gate to a unit quaternion, calculating an nth root of the unit quaternion, and mapping the nth root of the unit quaternion to a unitary matrix that represents a fractional single qubit gate. The method includes configuring the quantum circuit to include at least one fractional single qubit gate representing the unitary matrix in place of the single qubit gate for performing the addition.

### CROSS-REFERENCE TO RELATED APPLICATIONS

This application claims the benefit of U.S. Provisional Application No. 63/314,845, filed Feb. 28, 2022, which is herein incorporated by reference.

### BACKGROUND

Aspects of the present disclosure relate generally to systems and methods for use in the implementation and/or operation of quantum information processing (QIP) systems.

Trapped atoms are one of the leading implementations for quantum information processing or quantum computing. Atomic-based qubits may be used as quantum memories or as quantum gates in quantum computers and simulators, and may act as nodes for quantum communication networks. Qubits based on trapped atomic ions enjoy a rare combination of attributes. For example, qubits based on trapped atomic ions have very good coherence properties, may be prepared and measured with nearly 100% efficiency, and are readily entangled with each other by modulating their Coulomb interaction with suitable external control fields such as optical or microwave fields. These attributes make atomic-based qubits attractive for extended quantum operations such as quantum computations or quantum simulations.

It is therefore important to develop new techniques that improve the design, fabrication, implementation, and/or control of different QIP systems used as quantum computers or quantum simulators, and particularly for those QIP systems that handle operations based on atomic-based qubits.

### SUMMARY

The following presents a simplified summary of one or more aspects to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

This disclosure describes various aspects of systems and methods for the addition of qubit states using entangled quaternionic roots of single qubit gates.

In an exemplary aspect, the techniques described herein relate to a method for performing addition of qubit states using entangled quaternionic roots of single qubit gates. A method includes identifying a single qubit gate in a quantum circuit of a quantum computer, wherein the quantum circuit includes two summand qubits entangled with a third qubit that stores a measurable non-linear sum of the two summand qubits. The method includes mapping the single qubit gate to a representative gate that is phase-equivalent to the single qubit gate, and subsequently mapping the representative gate to a unit quaternion. The method includes calculating an nth root of the unit quaternion. The method includes mapping the nth root of the unit quaternion to a unitary matrix that represents a fractional single qubit gate. The method includes configuring the quantum circuit to include at least one fractional single qubit gate representing the unitary matrix in place of the single qubit gate for performing addition of the two summand qubits.

In some aspects, the techniques described herein relate to a quantum information processing (QIP) system that performs addition of qubit states using entangled quaternionic roots of single qubit gates. The QIP system includes a hardware processor configured to identify a single qubit gate in a quantum circuit, wherein the quantum circuit includes two summand qubits entangled with a third qubit that stores a measurable non-linear sum of the two summand qubits. The hardware processor maps the single qubit gate to a representative gate that is phase-equivalent to the single qubit gate, and maps the representative gate to a unit quaternion. The hardware processor calculates an nth root of the unit quaternion, and maps the nth root of the unit quaternion to a unitary matrix that represents a fractional single qubit gate. The hardware processor then configures the quantum circuit to include at least one fractional single qubit gate representing the unitary matrix in place of the single qubit gate for performing addition of the two summand qubits.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates a view of atomic ions a linear crystal or chain, in accordance with aspects of this disclosure.

FIG. 2 illustrates an example of a quantum information processing (QIP) system, in accordance with aspects of this disclosure.

FIG. 3 illustrates an example of a computer device, in accordance with aspects of this disclosure.

FIG. 4 illustrates an example of a fractional gate addition circuit, in accordance with aspects of this disclosure.

FIG. 5 illustrates an example of a simplified fractional gate addition circuit, in accordance with aspects of this disclosure.

FIG. 6 illustrates an example of another simplified fractional gate addition circuit, in accordance with aspects of this disclosure.

FIG. 7 illustrates example results of addition circuits fractional powers of X rotation and Hadamard gates as generators, in accordance with aspects of this disclosure.

FIG. 8 illustrates a flowchart of a method for performing addition of qubit states using entangled quaternionic roots of single qubit gates, in accordance with aspects of this disclosure.

### DETAILED DESCRIPTION

The detailed description set forth below in connection with the appended drawings or figures is intended as a description of various configurations or implementations and is not intended to represent the only configurations or implementations in which the concepts described herein may be practiced. The detailed description includes specific details for the purpose of providing a thorough understanding of various concepts. However, it will be apparent to those skilled in the art that these concepts may be practiced without these specific details or with variations of these specific details. In some instances, well known components are shown in block diagram form, while some blocks may be representative of one or more well-known components.

To improve performance of a quantum computer, it would be helpful to find the roots or powers of single qubit states and then add together these fractions to perform a kind of addition of quantum states.

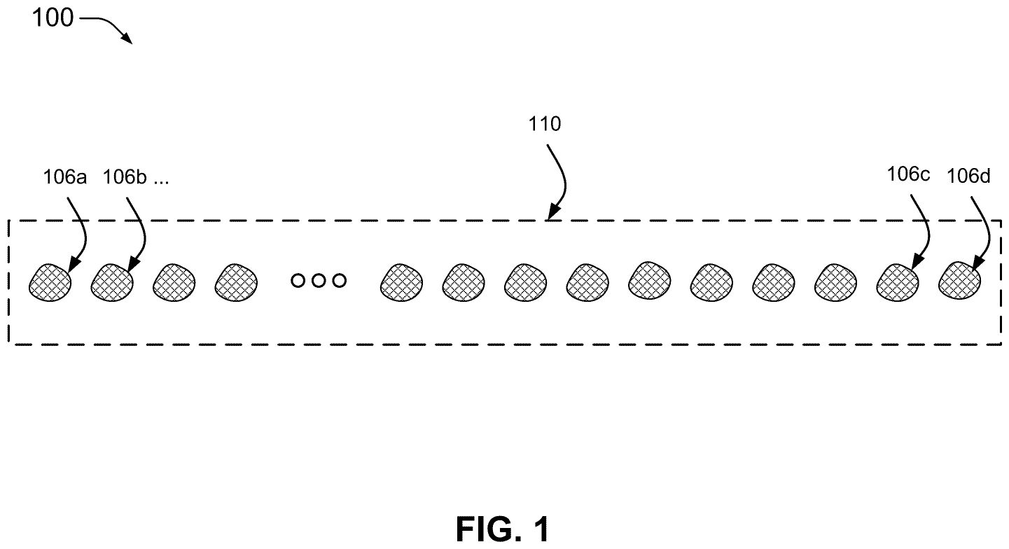

Solutions to the issues described above are explained in more detail in connection with FIGS. 1-8, with FIGS. 1-3 providing a background of QIP systems or quantum computers, and more specifically, of atomic-based QIP systems or quantum computers.

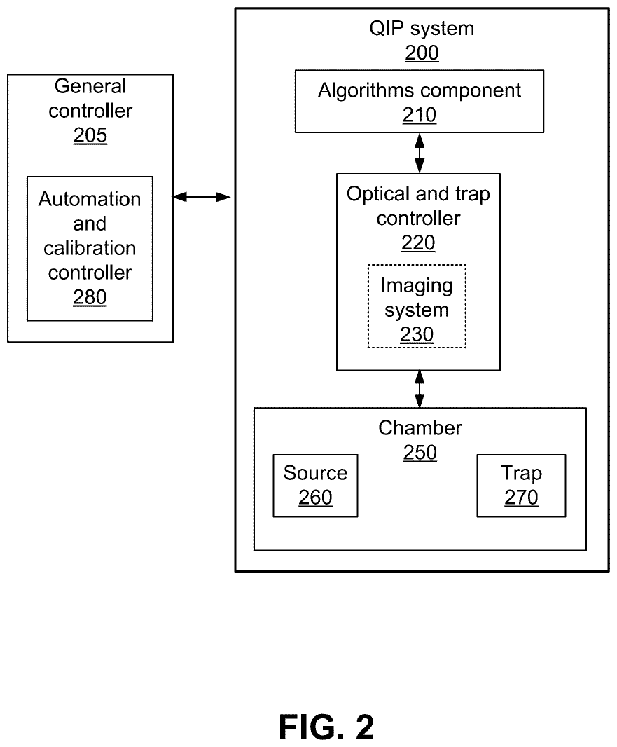

FIG. 1 illustrates a diagram 100 with multiple atomic ions 106 (e.g., atomic ions 106a, 106b, . . . , 106c, and 106d) trapped in a linear crystal or chain 110 using a trap (the trap can be inside a vacuum chamber as shown in FIG. 2). The trap maybe referred to as an ion trap. The ion trap shown may be built or fabricated on a semiconductor substrate, a dielectric substrate, or a glass die or wafer (also referred to as a glass substrate). The atomic ions 106 may be provided to the trap as atomic species for ionization and confinement into the chain 110.

In the example shown in FIG. 1, the trap includes electrodes for trapping or confining multiple atomic ions into the chain 110 that are laser-cooled to be nearly at rest. The number of atomic ions (N) trapped can be configurable and more or fewer atomic ions may be trapped. The atomic ions may be Ytterbium ions (e.g., ¹⁷¹Yb⁺ ions), for example. The atomic ions are illuminated with laser (optical) radiation tuned to a resonance in ¹⁷¹Yb⁺ and the fluorescence of the atomic ions is imaged onto a camera or some other type of detection device. In this example, atomic ions may be separated by about 5 microns (μm) from each other, although the separation may be smaller or larger than 5 μm. The separation of the atomic ions is determined by a balance between the external confinement force and Coulomb repulsion and does not need to be uniform. Moreover, in addition to atomic Ytterbium ions, neutral atoms, Rydberg atoms, different atomic ions or different species of atomic ions may also be used. The trap may be a linear RF Paul trap, but other types of confinement may also be used, including optical confinements. Thus, a confinement device may be based on different techniques and may hold ions, neutral atoms, or Rydberg atoms, for example, with an ion trap being one example of such a confinement device. The ion trap may be a surface trap, for example.

FIG. 2 is a block diagram that illustrates an example of a QIP system 200 in accordance with various aspects of this disclosure. The QIP system 200 may also be referred to as a quantum computing system, a quantum computer, a computer device, a trapped ion system, or the like. The QIP system 200 may be part of a hybrid computing system in which the QIP system 200 is used to perform quantum computations and operations and the hybrid computing system also includes a classical computer to perform classical computations and operations.

Shown in FIG. 2 is a general controller 205 configured to perform various control operations of the QIP system 200. Instructions for the control operations may be stored in memory (not shown) in the general controller 205 and may be updated over time through a communications interface (not shown). Although the general controller 205 is shown separate from the QIP system 200, the general controller 205 may be integrated with or be part of the QIP system 200. The general controller 205 may include an automation and calibration controller 280 configured to perform various calibration, testing, and automation operations associated with the QIP system 200.

The QIP system 200 may include an algorithms component 210 that may operate with other parts of the QIP system 200 to perform quantum algorithms or quantum operations, including a stack or sequence of combinations of single qubit operations and/or multi-qubit operations (e.g., two-qubit operations) as well as extended quantum computations. As such, the algorithms component 210 may provide instructions to various components of the QIP system 200 (e.g., to the optical and trap controller 220) to enable the implementation of the quantum algorithms or quantum operations. The algorithms component 210 may receive information resulting from the implementation of the quantum algorithms or quantum operations and may process the information and/or transfer the information to another component of the QIP system 200 or to another device for further processing.

The QIP system 200 may include an optical and trap controller 220 that controls various aspects of a trap 270 in a chamber 250, including the generation of signals to control the trap 270, and controls the operation of lasers and optical systems that provide optical beams that interact with the atoms or ions in the trap. When used to confine or trap ions, the trap 270 may be referred to as an ion trap. The trap 270, however, may also be used to trap neutral atoms, Rydberg atoms, different atomic ions or different species of atomic ions. The lasers and optical systems can be at least partially located in the optical and trap controller 220 and/or in the chamber 250. For example, optical systems within the chamber 250 may refer to optical components or optical assemblies.

The QIP system 200 may include an imaging system 230. The imaging system 230 may include a high-resolution imager (e.g., CCD camera) or other type of detection device (e.g., photomultiplier tube or PMT) for monitoring the atomic ions while they are being provided to the trap 270 and/or after they have been provided to the trap 270. In an aspect, the imaging system 230 may be implemented separately from the optical and trap controller 220. However, the use of fluorescence to detect, identify, and label atomic ions using image processing algorithms may need to be coordinated with the optical and trap controller 220.

In addition to the components described above, the QIP system 200 can include a source 260 that provides atomic species (e.g., a plume or flux of neutral atoms) to the chamber 250 having the trap 270. When atomic ions are the basis of the quantum operations, trap 270 confines the atomic species once ionized (e.g., photoionized). Trap 270 may be part of a processor or processing portion of the QIP system 200. That is, the trap 270 may be considered at the core of the processing operations of the QIP system 200 since it holds the atomic-based qubits that are used to perform the quantum operations or simulations. At least a portion of the source 260 may be implemented separate from the chamber 250.

It is to be understood that the various components of the QIP system 200 described in FIG. 2 are described at a high-level for ease of understanding. Such components may include one or more sub-components, the details of which may be provided below as needed to better understand certain aspects of this disclosure.

Aspects of this disclosure may be implemented at least partially using the general controller 205, the automation and calibration controller 280, and/or the algorithms component 210. These and/or components of the QIP system 200 may be used in connection with the techniques for the addition of qubit states using entangled quaternionic roots of single qubit gates described herein.

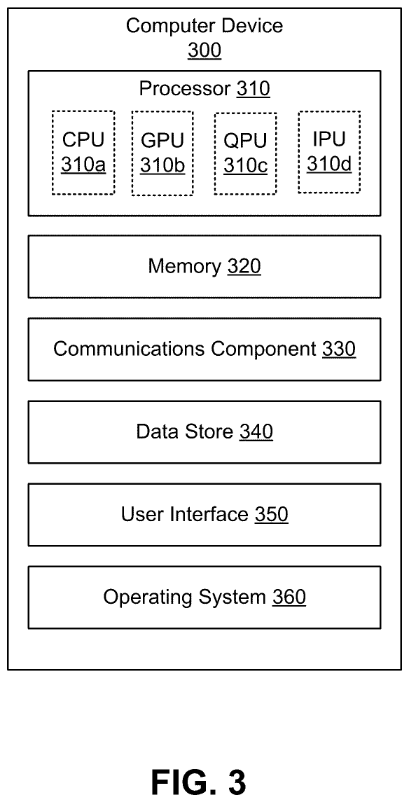

Referring now to FIG. 3, illustrated is an example of a computer system or device 300 in accordance with aspects of the disclosure. The computer device 300 can represent a single computing device, multiple computing devices, or a distributed computing system, for example. The computer device 300 may be configured as a quantum computer (e.g., a QIP system), a classical computer, or to perform a combination of quantum and classical computing functions, sometimes referred to as hybrid functions or operations. For example, the computer device 300 may be used to process information using quantum algorithms, classical computer data processing operations, or a combination of both. In some instances, results from one set of operations (e.g., quantum algorithms) are shared with another set of operations (e.g., classical computer data processing). A generic example of the computer device 300 implemented as a QIP system capable of performing quantum computations and simulations is, for example, the QIP system 200 shown in FIG. 2.

The computer device 300 may include a processor 310 for carrying out processing functions associated with one or more of the features described herein. The processor 310 may include a single or multiple set of processors or multi-core processors. Moreover, the processor 310 may be implemented as an integrated processing system and/or a distributed processing system. The processor 310 may include one or more central processing units (CPUs) 310a, one or more graphics processing units (GPUs) 310b, one or more quantum processing units (QPUs) 310c, one or more intelligence processing units (IPUs) 310d (e.g., artificial intelligence or AI processors), or a combination of some or all those types of processors. In one aspect, the processor 310 may refer to a general processor of the computer device 300, which may also include additional processors 310 to perform more specific functions (e.g., including functions to control the operation of the computer device 300).

The computer device 300 may include a memory 320 for storing instructions executable by the processor 310 to carry out operations. The memory 320 may also store data for processing by the processor 310 and/or data resulting from processing by the processor 310. In an implementation, for example, the memory 320 may correspond to a computer-readable storage medium that stores code or instructions to perform one or more functions or operations. Just like the processor 310, the memory 320 may refer to a general memory of the computer device 300, which may also include additional memories 320 to store instructions and/or data for more specific functions.

It is to be understood that the processor 310 and the memory 320 may be used in connection with different operations including but not limited to computations, calculations, simulations, controls, calibrations, system management, and other operations of the computer device 300, including any methods or processes described herein.

Further, the computer device 300 may include a communications component 330 that provides for establishing and maintaining communications with one or more parties utilizing hardware, software, and services. The communications component 330 may also be used to carry communications between components on the computer device 300, as well as between the computer device 300 and external devices, such as devices located across a communications network and/or devices serially or locally connected to computer device 300. For example, the communications component 330 may include one or more buses, and may further include transmit chain components and receive chain components associated with a transmitter and receiver, respectively, operable for interfacing with external devices. The communications component 330 may be used to receive updated information for the operation or functionality of the computer device 300.

Additionally, the computer device 300 may include a data store 340, which can be any suitable combination of hardware and/or software, which provides for mass storage of information, databases, and programs employed in connection with the operation of the computer device 300 and/or any methods or processes described herein. For example, the data store 340 may be a data repository for operating system 360 (e.g., classical OS, or quantum OS, or both). In one implementation, the data store 340 may include the memory 320. In an implementation, the processor 310 may execute the operating system 360 and/or applications or programs, and the memory 320 or the data store 340 may store them.

The computer device 300 may also include a user interface component 350 configured to receive inputs from a user of the computer device 300 and further configured to generate outputs for presentation to the user or to provide to a different system (directly or indirectly). The user interface component 350 may include one or more input devices, including but not limited to a keyboard, a number pad, a mouse, a touch-sensitive display, a digitizer, a navigation key, a function key, a microphone, a voice recognition component, any other mechanism capable of receiving an input from a user, or any combination thereof. Further, the user interface component 350 may include one or more output devices, including but not limited to a display, a speaker, a haptic feedback mechanism, a printer, any other mechanism capable of presenting an output to a user, or any combination thereof. In an implementation, the user interface component 350 may transmit and/or receive messages corresponding to the operation of the operating system 360. When the computer device 300 is implemented as part of a cloud-based infrastructure solution, the user interface component 350 may be used to allow a user of the cloud-based infrastructure solution to remotely interact with the computer device 300.

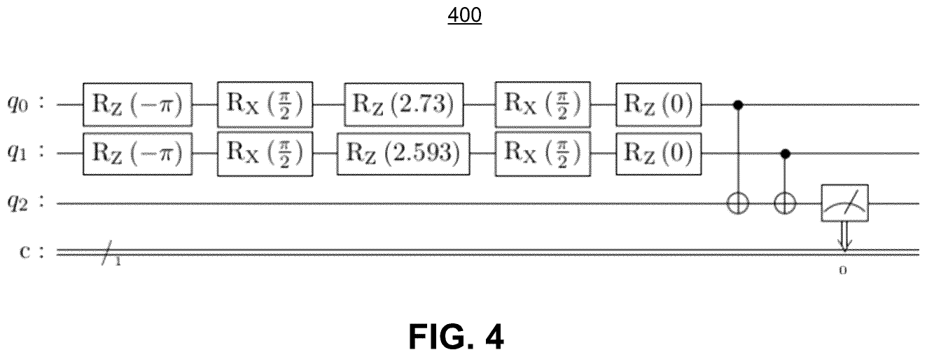

In connection with the systems described in FIGS. 1-3, and with further details provided in FIGS. 4-8 below, the present disclosure provides various aspects of techniques for the addition of qubit states using entangled quaternionic roots of single qubit gates.

In a high-level overview, algorithms component 210 can be configured to map unitary matrices to special unitary matrices by adjusting phase. Using the correspondence between the special unitary matrices and quaternions, algorithms component 210 can be configured to map each of the special unitary matrices to a corresponding quaternion. Subsequently, algorithms component 210 can employ de Moivre's formula to calculate the roots of the quaternions and map each of the roots back to a special unitary matrix that is a suitable “root” of the initial matrix. Algorithms component 210 can then use pairs of fractional gates to prepare two “summand” qubits, and entangle each of the summand qubits with a third qubit that stores a typically non-linear “sum” of the two summand qubits. The circuit associated with this addition may then be implemented on hardware by optical and trap controller 220.

The technique described herein for the addition of qubit states using entangled quaternionic roots of single qubit gates involves a 3-qubit implementation of a circuit for non-linearly adding quantum states together.

A basic example is provided below as an illustration that demonstrates a circuit in which the input angles θ and φ are combined in such a way that the probability of observing a |1 [symbol] output is given by

$${cos}^{2} ( \frac{θ}{2} ) {sin}^{2} ( \frac{φ}{2} ) + {sin}^{2} ( \frac{θ}{2} ) {cos}^{2} ( \frac{φ}{2} ) .$$

The method relies on the following observations. Firstly, single qubit gates may be represented by unit quaternions. Second, fractional real roots of quaternions may be represented using the quaternionic version of the de Moivre formula: (cos(θ)+i sin(θ))ⁿ=cos(nθ)+i sin(nθ). Third, the first two observations may be combined to generate a general formulation for a “fractional single qubit gate.” Fourth, a single CNOT gate effectively passes on such a fractional rotation to its target bit. Fifth, when two such fractional rotations through angles θ and φ are combined into the same target bit, this gives an outcome probability that is a function F of θ and φ. Lastly, particular rotations and ranges for θ and φ can be chosen such that F is at least monotonically increasing in both θ and φ. This can be used as a proxy for “addition,” or at least some function that accumulates the weights θ and φ.

It should be noted that this method is different from any quantum adder circuits that involve integer addition and rely on using n-qubits to discretely represent 2ⁿ bits. Likewise, optimizations obtained using the Fast Fourier Transform speed up computation, but still use the same discrete representation rather than using the continuous nature of vector coordinates or angles to represent a continuum of real numbers. A unitary transformation that takes |Ψ₁ [symbol] and |Ψ₂ [symbol] as inputs and produces an output |Ψ₁ [symbol] +|Ψ₂ [symbol] is physically impossible.

Conventional attempts at addition lack both the use of fractional quaternionic roots to represent fractional roots of any single qubit gate, and the use of two CNOT gates to combine such fractions into a “sum” (at least, a function of both inputs that may be monotonically increasing).

Quaternions [symbol] are a 4-dimensional real algebra generated by the identity element 1 and the symbols i, j, and k, multiplied according to the quaternion relations:

ij=−ji=k jk=−kj=i ki=−ik=j i²=j²=k²=−1

and the distributive law. The quaternion algebra is not commutative, though it does obey the associative law. The quaternions are a division algebra (an algebra with the property that ab=0 implies that a=0 or b=0).

Each of the generators i, j, k behaves like a “square root of negative one,” and more generally, so does every imaginary quaternion ai+bj+ck with a²+b²+c²=1. Identifying such an ai+bj+ck with the imaginary number i gives an embedding of the complex numbers [symbol] → [symbol] . The set of possible square roots of negative one can be identified with the 2-sphere S². A quaternion q=q₀+q₁i+q₂j+q₃k can be decomposed into its real part q and its imaginary part q₁i+q₂j+q₃k.

As with complex numbers, the conjugate of a quaternion q=q₀+q₁i+q₂j+q₃k is defined as q̅=q₀−q₁i−q₂j−q₃k, the norm of a quaternion is given by the formula |q|=qq̅, and the inverse is given by q⁻¹=q̅/|q|. Quaternions have a polar decomposition q=|q|(cos(θ)+a sin(θ))=|q|e^{aθ}, where a is one of the 2-sphere of imaginary quaternions.

Unit quaternions are those with a unit norm. A unit quaternion q can therefore be written as q=cos(θ)+a sin(θ), for some imaginary a∈ [symbol] such that a²=−1.

In connection with this disclosure, the de Moivre formula (cos(θ)+i sin(θ))ⁿ=cos(nθ)+i sin(nθ) applies unchanged to the quaternionic setting. That is, for a unit quaternion: q=cos(θ)+a sin(θ) and qⁿ=cos(nθ)+a sin(nθ).

This adapts immediately to fractional real roots: p=qⁿ=cos(nθ)+a sin(nθ). It follows that q=p^{1/n}, so when setting φ=nθ, it follows that if p=cos(φ)+a sin(φ), then:

p^{1/n}=cos(φ/n)+a sin(φ/n) (Equation 1)

In general, quaternion roots, like complex roots, are usually not uniquely defined. Since any multiple of 2π can be added to the angle φ and represent the same quaternion p, so typically the equation q=p^{1/n} has n roots if n is an integer, infinitely many roots if n is irrational, with special cases for when p is real.

The group Sp(1) of unit quaternions under multiplication is isomorphic to the multiplicative group SU(2) of 2×2 special unitary (complex) matrices, with a correspondence given by:

$$q = a + bi + cj + dk ↔ ( \begin{matrix}a + bi & c + di \\ - c + di & a - bi\end{matrix} ) . \qquad ( Equation 2 )$$

This establishes the isomorphism Sp(1)≅SU(2).

Quantum gates are unitary transformations, and single-qubit gates are unitary transformations on vectors in [symbol] ². Thus, single-qubit gates are identified with the group U(2). Unitary matrices have determinants in the complex circle group U(1), whereas special unitary matrices are those with determinant equal to 1. Accordingly, the group U(2) is more general than the normal subgroup SU(2), from which it follows that not all unitary matrices representing single-qubit quantum gates have corresponding quaternions given by the correspondence in Equation 2.

However, this can be mitigated by selecting appropriate phase factors. Because multiplying any quantum state |Ψ [symbol] by a unit phase factor e^{iθ}∈U(1) has no physical effect: |Ψ [symbol] and e^{iθ}|Ψ [symbol] are physically identical. Algorithms component 210 may perform phase-independent comparison between two unitary matrices by first mapping each to a canonical representative with unit determinant.

For any gate A∈U(n), simple matrix multiplication shows that A(e^{iθ}|Ψ [symbol] )=e^{inθ}A(|Ψ [symbol] ). If multiplication by a phase factor does not change physical states, it also does not change physical operators. Suppose that det(A)=e^{iθ}. It follows that det(e^{-iθ/n}A)=1, and that this operator produces the same physical state as A.

Thus, algorithms component 210 defines a mapping A→det(A)^{1/n}A, which assigns to each unitary matrix a special unitary matrix with the same physical effect. This mapping is in fact a fibration mapping U(2)→SU(2). For n=2, each unitary matrix has two possible special unitary images under this mapping, because if det(A)=1 then det(−A)=1. This corresponds to the multiplicity of roots in the expression det(A)^{1/n}. In algebraic terms, U(2) is not a direct product SU(2)⊕U(1), though there is a short exact sequence 1→SU(2)→U(2)→U(1)→1.

The strategy for finding “roots” of a single qubit quantum logic gate A then takes shape. To find a gate B such that Bⁿ=A for some root n, algorithms component 210 may take any gate A∈U(2) and map it to a representative gate A′∈SU(2) using the formula A′=det(A)^{1/n}A. Algorithms component 210 may then map A′∈SU(2) to a unit quaternion q∈Sp(1) using the correspondence highlighted in Equation 2. Algorithms component 210 then takes the n^{th} root q^{1/n} using Equation 1 and maps the result to a special unitary matrix B′ using Equation 2. In some aspects, QIP system 200 may store the mappings from quaternions to special unitary matrices and vice versa in a database in memory. From the isomorphism Sp(1)≅SU(2), it follows that (B′)ⁿ=A′.

In some aspects, to recover the matrix A as well as the phase-equivalent A′, algorithms component 210 may multiply B′ by a phase factor det(A)^{1/2n}, and verify that if B=det(A)^{1/2n}B′, then Bⁿ=A.

The addition of qubit states using entangled quaternionic roots of single-qubit gates is then implemented on physical quantum hardware on a trapped-ion quantum computer (e.g., QIP system 200 as described above). The implementation requires no new hardware components, but instead configures the compilation process to enable fractional versions of existing GPi2 rotation gates, which are gates set to always rotate through an angle of n/2 radians. Enabling fractional versions of GPi2 rotation gates suggests that the GPi2 rotation gates may rotate on any longitudinal axis of the Bloch sphere.

The homogeneous nature of the group of unit quaternions is often explained as part of introducing quaternions. For example, it is understood that all imaginary quaternions are equivalent “square roots of −1.” This encourages generalizing the common X- and Y-rotations to other axes of rotation. The ability to rotate around any longitudinal axis of the Bloch sphere corresponds to the ability to use any unit quaternion of the form aj+bk as a rotation axis, rather than just the X- and Y-rotations supported explicitly in packages such as qiskit and Cirq.

Removing the restriction that the angle of rotation must be π enables the direct implementation of a gate that rotates through a fractional angle θ, around any axis in the plane spanned by the unit quaternions j and k (equivalently, around any angle between the X- and Y-axes). Based on testing, the removal of the restriction reduces the number of single-qubit native gates needed to implement standard benchmarking circuits, by between 25% and 30%. An example of this is provided in FIGS. 4-6. It should also be noted that, while the implementation here takes advantage of specific details in the construction of IonQ trapped-ion native gates, analogous constructions are possible with other qubit types.

FIG. 4 illustrates an example of a fractional gate addition circuit 400, in accordance with aspects of this disclosure. Circuit 400 includes two summand qubits q₀ and q₁, each of which are put through a single qubit fractional gate transformation. The combination of 5 single qubit gates is due to the explicit implementation of the U gate. More specifically, q₀ is put through the following qubit gates: R_{z}(−π), Rₓ(π/2), R_{z}(2.73), Rₓ(π/2), R_{z}(0). Likewise, q₁ is put through: R_{z}(−π), Rₓ(π/2), R_{z}(2.593), Rₓ(π/2), R_{z}(0). These qubits are connected to a third sum qubit, q₂, using two CNOT gates. The resulting sum qubit is then measured.

In a technical implementation, R_{z}(λ) and R(θ,φ) are rotation matrices, which are the notation standardly used in the quantum compiler layer. It should be noted that the gate R_{z}(λ) corresponds to the quaternion cos(λ)+i sin(λ) and the gate R(θ,φ) corresponds to the quaternion cos(θ)+j sin(θ)cos(φ)+k sin(θ)sin(φ). Based on the steps described in the present disclosure such as: taking a gate; mapping the gate to a representative gate that is phase-equivalent to the gate; mapping the representative gate to a unit quaternion; taking the nth root of the unit quaternion; and mapping back a result of the nth root to a special unitary matrix, circuit 400 can be simplified to use fewer gates, which improves the performance and efficiency (e.g., reducing consumption of resources) of QIP system 200.

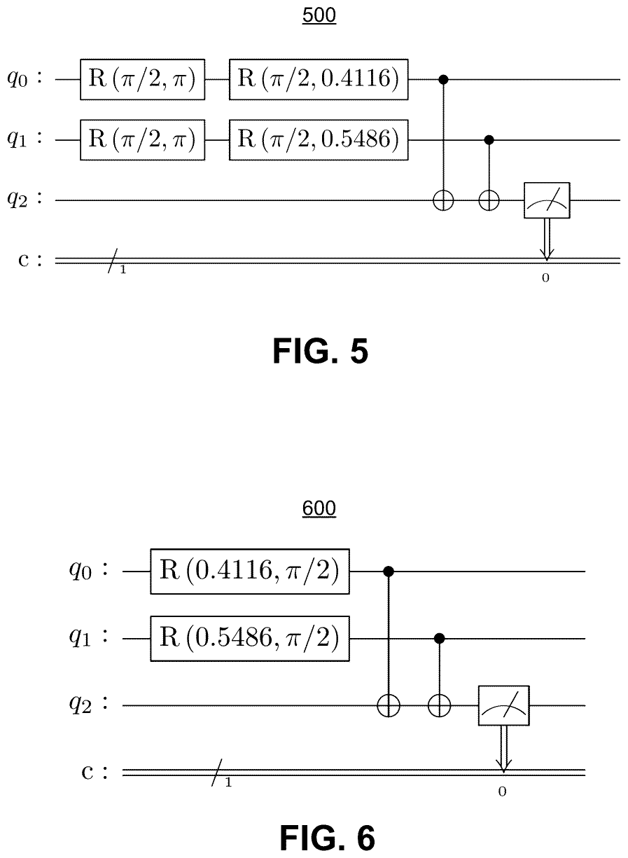

FIG. 5 illustrates an example circuit 500 in which the phases (R_{z} operations) of circuit 400 are propagated and expressed in terms of two GPi2 pulses, in accordance with aspects of this disclosure. In particular, algorithms component 210 may implement phase tracking, which uses the property R_{z}(−λ)R(θ,φ)R_{z}(λ)=R(θ,φ+λ). Because R_{z}(λ) corresponds to the quaternion cos(λ)+i sin(λ) and the gate R(θ,φ) corresponds to the quaternion cos(θ)+j sin(θ)cos(φ)+k sin(θ)sin(φ), this property can be expressed using quaternions. This property is used to move R_{z} gates through circuit 400. For example, the first qubit goes through gates: R_{z}(−π)Rₓ(π/2)R_{z}(2.73)Rₓ(π/2)R_{z}(0). Using the property that Rₓ(π/2)=R(π/2,0)=R_{z}(−π)R(π/2,π)R_{z}(π)=R_{z}(−π)Rₓ(−π/2)R_{z}(π), algorithms component 210 determines that R_{z}(−π)Rₓ(π/2)R_{z}(2.73−π)Rₓ(−π/2)R_{z}(π).

Employing the R_{z} property in a chain, algorithms component 210 propagates R_{z}(π) from one side to the other, adding the phases on Rₓ (R_{z} in the middle is not affected): Rₓ(−π/2)R_{z}(2.73−π)Rₓ(π/2). To obtain circuit 500, algorithms component 210 moves the R_{z} gate to the right to achieve Rₓ(−π/2)R_{z}(2.73−π)Rₓ(π/2)=R(π/2,π)R(π/2,π−2.73)R_{z}(2.73−π)=R(π/2,π)R(π/2,0.4116)R_{z}(−0.4116). Because the last R_{z} gate commutes with the control on the CNOT gate, the R_{z} gate may be ignored. This leaves two pulses: R(π/2,π)R(π/2,0.4116). Using the same properties, algorithms component 210 employs phase tracking for q₁ to yield R(π/2,π)R(π/2,0.5486) as shown in FIG. 5. Circuit 400 and circuit 500 yield the same result at the measurement of q₂. However, circuit 500 uses fewer gates and is more efficient computationally.

FIG. 6 illustrates an example circuit 600 in which the pulses of circuit 400 are merged into corresponding arbitrary angle pulses. For example, in circuit 600, q₀ goes through a single gate R(0.4116,π/2) and q₁ also goes through a single gate R(0.5486,π/2). Circuit 400 and circuit 600 yield the same result at the measurement of q₂. However, circuit 600 uses fewer gates and is more efficient computationally. In order to arrive at circuit 600 from circuit 400, algorithms component 210 employs the property that Rₓ(−π/2)R_{z}(−θ)Rₓ(π/2)=R_{y}(θ). Accordingly, for q₀, for example, Rₓ(−π/2)R_{z}(2.73−π)Rₓ(π/2)=R_{y}(π−2.73)=R(0.4116,π/2). Using the same properties, algorithms component 210 yields R(0.5486,π/2) for q₁ as shown in FIG. 6.

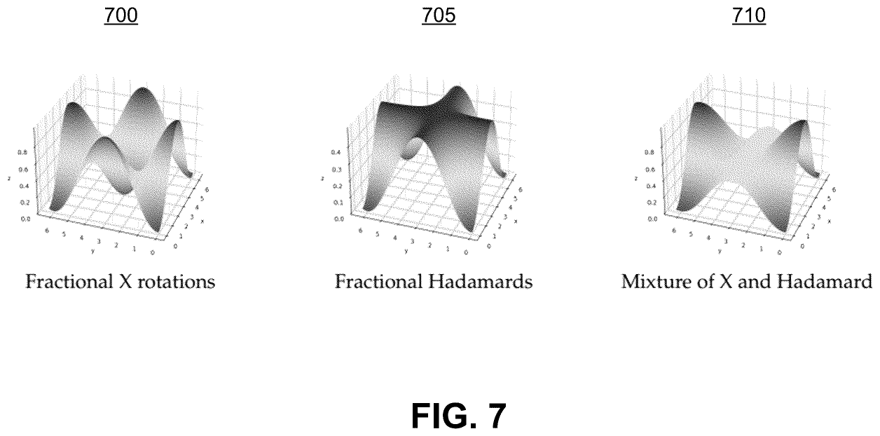

FIG. 7 illustrates three graphs depicting example results from the circuit in FIG. 4. The generators are chosen to be fractional powers of X gates in graph 700, Hadamard gates in graph 705, and a mixture in graph 710. Around the origin, each combination is monotonically increasing as both the input angles increase. Thus, for small angles, the result can be regarded as “non-linear addition.” Larger angles exhibit periodic behavior as expected. This is different depending on the fractional generators used. For example, the period of the X rotations combines additively, whereas with the fractional Hadamard generators, if either summand is around the value π, the output is close to 1. This can be thought of as a continuous analogy to XOR logic. With a mixture of X rotation and Hadamard generators, a combination of these behaviors is observed.

For the case of where the summands are prepared using two X rotations through angles θ and φ, the expected probability of measuring a |1 [symbol] on the sum qubit is given by

$${cos}^{2} ( \frac{θ}{2} ) {sin}^{2} ( \frac{φ}{2} ) + {sin}^{2} ( \frac{θ}{2} ) {cos}^{2} ( \frac{φ}{2} ) .$$

This prediction is confirmed in the simulation runs used for the results in FIG. 7, and in a few ad hoc examples run on trapped-ion quantum computing hardware.

In addition to circuit simplification as shown in FIGS. 4-6, there are various benefits offered by the techniques described in the present disclosure. As mentioned above, mapping each unitary matrix to a corresponding special unitary representative may be distinctively useful to address the problem of measuring phase-independent equality/similarity between unitary operators. In addition, quantum addition for fractional states may be applied for machine learning operations such as unigram (bag-of-words) classification. The techniques described herein may be generalized to more than two inputs (e.g., summands). The concept of combining several input signals monotonically (but not necessarily linearly) into an output weight, with a quantum circuit activation function, is especially applicable in neural networks.

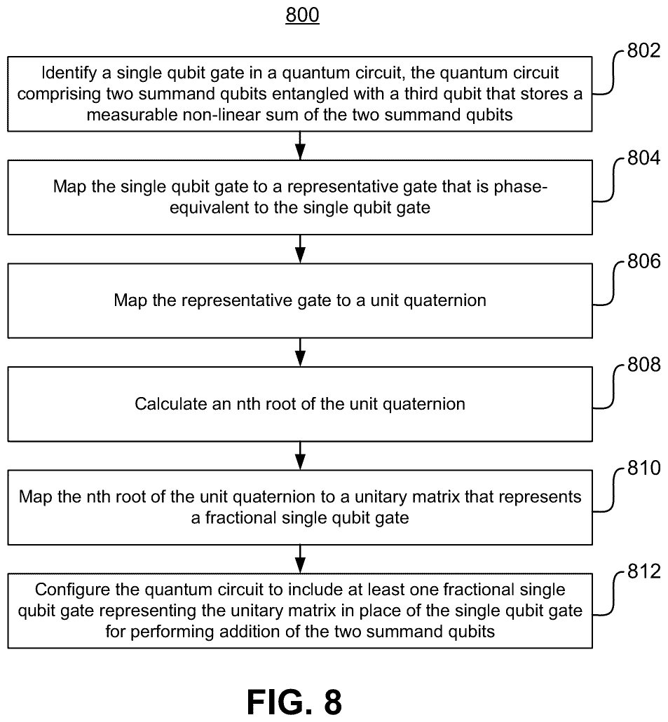

FIG. 8 illustrates a flowchart of method 800 for performing addition of qubit states using entangled quaternionic roots of single qubit gates, in accordance with aspects of this disclosure. The exemplary method 800 can be implemented using the systems and components described above with respect to FIGS. 2 and/or 3.

In particular, at 802, processor 310 identifies a single qubit gate in a quantum circuit (e.g., of QIP system 200 or computer device 300). The quantum circuit may include two summand qubits entangled with a third qubit that stores a measurable non-linear sum of the two summand qubits. In some aspects, the two summand qubits are connected to the third qubit using two CNOT gates.

At 804, processor 310 maps the single qubit gate to a representative gate that is phase-equivalent to the single qubit gate using the exemplary techniques described herein. In some aspects, a matrix representation of the representative gate has a determinant equal to 1. In some aspects, the matrix representation of the representative gate is a product of the single qubit gate and an nth root of a determinant of the single qubit gate. For example, if the matrix representation of the single qubit gate is A and the matrix representation of the representative gate is A′, then A′=det(A)^{1/n}A.

At 806, processor 310 maps the representative gate to a unit quaternion q. In some aspects, mapping the representative gate to the unit quaternion is based on a correspondence

$$a + bi + cj + dk ↔ ( \begin{matrix}a + bi & c + di \\ - c + di & a - bi\end{matrix} ) ,$$

wherein a+bi+cj+dk is the unit quaternion and

$$( \begin{matrix}a + bi & c + di \\ - c + di & a - bi\end{matrix} )$$

is a matrix structure of the representative gate.

At 808, processor 310 calculates an nth root of the unit quaternion. In some aspects, algorithms component 210 executes de Moivre's formula (i.e., (cos(θ)+i sin(θ))ⁿ=cos(nθ)+i sin(nθ)) to calculate the nth root. For quaternions, the equation is thus p^{1/n}=cos(φ/n)+a sin(φ/n).

At 810, algorithms component 210 maps the nth root of the unit quaternion to a unitary matrix B′ that represents a fractional single qubit gate. In some aspects, mapping the nth root of the unit quaternion to the unitary matrix is also based on the correspondence

$$a + bi + cj + dk ↔ ( \begin{matrix}a + bi & c + di \\ - c + di & a - bi\end{matrix} ) ,$$

wherein a+bi+cj+dk is the structure of the nth root of the unit quaternion and

$$( \begin{matrix}a + bi & c + di \\ - c + di & a - bi\end{matrix} )$$

is a matrix structure of the unitary matrix.

In some aspects, processor 310 may then verify whether a phase-equivalent of the unitary matrix is the fractional single qubit gate. More specifically, processor 310 may determining a product of the unitary matrix and a square-nth root of a determinant of a matrix representation of the single qubit gate (i.e., B=det(A)^{1/2n}B′). In response to determining that the matrix representation of the single qubit gate equals the product raised to an nth power (i.e., Bⁿ=A), processor 310 confirms that the phase-equivalent of the unitary matrix is the fractional single qubit gate.

In response to the verification, method 800 proceeds to 812, where processor 310 configures the quantum circuit to include at least one fractional single qubit gate representing the unitary matrix in place of the single qubit gate for performing addition of the two summand qubits. For example, processor 310 may replace each occurrence of the single qubit gate in the quantum circuit with the fractional single qubit gate. In some aspects, each of the single qubit gate(s) may be replaced with multiple fractional single qubit gate(s) (e.g., n fractional gates).

In some aspects, configuring the quantum circuit further comprises enabling a compiler of the quantum computer to support fractional versions of single qubit gates (e.g., GPi2 rotation gates on the QIP system 200 as described above, for example).

In general, it is noted that the previous description of the disclosure is provided to enable a person skilled in the art to make or use the disclosure. Various modifications to the disclosure will be readily apparent to those skilled in the art, and the common principles defined herein may be applied to other variations without departing from the scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

What is claimed is:

1. A method for performing addition of qubit states using entangled quaternionic roots of single qubit gates, the method comprising:
identifying a single qubit gate in a quantum circuit of a quantum computer, the quantum circuit comprising two summand qubits entangled with a third qubit configured to store a measurable non-linear sum of the two summand qubits;
mapping the single qubit gate to a representative gate that is phase-equivalent to the single qubit gate;
mapping the representative gate to a unit quaternion;
calculating an nth root of the unit quaternion;
mapping the nth root of the unit quaternion to a unitary matrix that represents a fractional single qubit gate; and
configuring the quantum circuit to include at least one fractional single qubit gate representing the unitary matrix in place of the single qubit gate for performing addition of the two summand qubits.

2. The method of claim 1, wherein the two summand qubits are connected to the third qubit using two CNOT gates.

3. The method of claim 1, wherein a matrix representation of the representative gate has a determinant equal to 1.

4. The method of claim 1, wherein a matrix representation of the representative gate is a product of the single qubit gate and an nth root of a determinant of the single qubit gate.

5. The method of claim 1, wherein mapping the representative gate to the unit quaternion is based on a correspondence
$$a + bi + cj + dk ↔ ( \begin{matrix}a + bi & c + di \\ - c + di & a - bi\end{matrix} ) ,$$
wherein a+bi+cj+dk is the unit quaternion and
$$( \begin{matrix}a + bi & c + di \\ - c + di & a - bi\end{matrix} )$$
is a matrix structure of the representative gate.

6. The method of claim 1, wherein calculating the nth root of the unit quaternion comprises executing a de Moivre's formula.

7. The method of claim 1, wherein configuring the quantum circuit is in response to verifying that a phase-equivalent of the unitary matrix is the fractional single qubit gate.

8. The method of claim 7, wherein verifying that the phase-equivalent of the unitary matrix is the fractional single qubit gate comprises:
determining a product of the unitary matrix and a square-nth root of a determinant of a matrix representation of the single qubit gate;
in response to determining that the matrix representation of the single qubit gate equals the product raised to an nth power, verifying that the phase-equivalent of the unitary matrix is the fractional single qubit gate.

9. The method of claim 1, wherein configuring the quantum circuit further comprises enabling a compiler of the quantum computer to support fractional versions of single qubit gates.

10. A quantum information processing (QIP) system that performs addition of qubit states using entangled quaternionic roots of single qubit gates comprising:
a hardware processor configured to:
identify a single qubit gate in a quantum circuit, the quantum circuit comprising two summand qubits entangled with a third qubit configured to store a measurable non-linear sum of the two summand qubits;
map the single qubit gate to a representative gate that is phase-equivalent to the single qubit gate;
map the representative gate to a unit quaternion;
calculate an nth root of the unit quaternion;
map the nth root of the unit quaternion to a unitary matrix that represents a fractional single qubit gate; and
configure the quantum circuit to include at least one fractional single qubit gate representing the unitary matrix in place of the single qubit gate for performing addition of the two summand qubits.

11. The QIP system of claim 10, wherein the two summand qubits are connected to the third qubit using two CNOT gates.

12. The QIP system of claim 10, wherein a matrix representation of the representative gate has a determinant equal to 1.

13. The QIP system of claim 10, wherein a matrix representation of the representative gate is a product of the single qubit gate and an nth root of a determinant of the single qubit gate.

14. The QIP system of claim 10, wherein mapping the representative gate to the unit quaternion is based on a correspondence
$$a + bi + cj + dk equals ( \begin{matrix}a + bi & c + di \\ - c + di & a - bi\end{matrix} ) ,$$
wherein a+bi+cj+dk is the unit quaternion and
$$( \begin{matrix}a + bi & c + di \\ - c + di & a - bi\end{matrix} )$$
is a matrix structure of the representative gate.

15. The QIP system of claim 10, wherein the hardware processor is configured to calculate the nth root of the unit quaternion by executing a de Moivre's formula.

16. The QIP system of claim 10, the hardware processor configures the quantum circuit in response to verifying that a phase-equivalent of the unitary matrix is the fractional single qubit gate.

17. The QIP system of claim 16, wherein the hardware processor is configured to verify that the phase-equivalent of the unitary matrix is the fractional single qubit gate by:
determining a product of the unitary matrix and a square-nth root of a determinant of a matrix representation of the single qubit gate;
in response to determining that the matrix representation of the single qubit gate equals the product raised to an nth power, verifying that the phase-equivalent of the unitary matrix is the fractional single qubit gate.

18. The QIP system of claim 10, further comprising a compiler, wherein the hardware processor configures the quantum circuit by enabling the compiler to support fractional versions of single qubit gates.
